(19) United States
(12) Patent Application Publication
(10) Pub. No.: US 2003/0053643 A1
(43) Pub. Date: Mar. 20, 2003

(54) Apparatus comprising a vibration component

(75) Inventors: Graham Bank, Woodbridge (GB); Martin Christopher Cassey, Cambridge (GB); Neil Simon Owen, Huntingdon (GB); Neil Harris, Cambridge (GB); Martin Colloms, London (GB)

Correspondence Address: FOLEY AND LARDNER, SUITE 500, 3000 K STREET NW, WASHINGTON, DC, 20007, US

(73) Assignee: NEW TRANSDUCERS LIMITED

(21) Appl. No.: 10/200,038

(22) Filed: Jul. 22, 2002

Related U.S. Application Data
(63) Continuation-in-part of application No. 09/768,002, filed on Jan. 24, 2001.
(60) Provisional application No. 60/309,871, filed on Aug. 6, 2001.
(60) Provisional application No. 60/178,315, filed on Jan. 27, 2000.
(60) Provisional application No. 60/205,465, filed on May 19, 2000.
(60) Provisional application No. 60/218,062, filed on Jul. 13, 2000.

(30) Foreign Application Priority Data
Aug. 1, 2001 (GB) 0118757.4

(51) Int. Cl. H04R 25/00; H04R 1/00; H04R 9/06; H04R 11/02

(52) U.S. Cl. 381/152; 381/190; 381/191; 381/431

(57) ABSTRACT

A device comprising a vibration system having a vibration component capable of vibrating and an electromechanical force transducer mounted to the component to excite vibration in the component. The transducer has an intended operative frequency range and comprises a resonant element having a frequency distribution of modes in the operative frequency range and coupler for mounting the transducer to the component.

This application claims the benefit of U.S. Provisional Application Serial No. 60/309,871 filed Aug. 6, 2001 (incorporated by reference in its entirety) and is a continuation-in-part application of U.S. patent application Ser. No. 09/768,002 filed Jan. 24, 2001, which claims the benefit of U.S. Provisional Application Serial No. 60/178,315, filed Jan. 27, 2000; No. 60/205,465, filed May 19, 2000 and 60/218,062, filed Jul. 13, 2000.

### TECHNICAL FIELD

This invention relates to devices comprising vibration components, for example, devices comprising vibrating sound emitters.

### BACKGROUND ART

It is known that the addition of a vibration component to many mechanically operated machines may improve their effectiveness since the added vibration may enhance the mechanical action of the mechanism. However, a vibration component is rarely added since it is often difficult to fit such vibration devices to the moving machinery. Disadvantages of previous attempts to provide vibration components include local stiffening about the location of the vibration component and insufficient input powers at low frequencies.

Furthermore, various ultrasonic devices are known such as the prior art personnel location device shown in FIGS. 1A and 1B. The device comprises a case (20) to which two active ultrasonic transmitters (22, 24) have been mounted. A first transmitter (22) is mounted on the front face of the case (20) and a second transmitter (24) is mounted on the top of the case (20). The case (20) also houses a circuit board (26) having components (28) which drive the two ultrasonic transmitters (22,24). Output from the circuit board (26) is fed to the ultrasonic transmitters by way of wires (30). The device is portable since it is powered by a battery (32) and a clip (34) is attached to the case (20) which allows the device to be fixed to a convenient position on a users clothing. The device has the disadvantage that the transmitters require apertures in the case.

Thus, it is desirable to provide an improved device or machine.

### SUMMARY OF THE INVENTION

According to the invention, there is provided a device comprising a vibration system having a vibration component capable of vibrating and an electromechanical force transducer mounted to the component to excite vibration in the component, characterised in that the transducer has an intended operative frequency range and comprises a resonant element having a frequency distribution of modes in the operative frequency range and a coupler for mounting the transducer to the component. The coupler may be mounted on the resonant element.

The operative frequency range may be in the audio range. The device may be selected from the group consisting of a dog whistle, a smoke alarm, a rape alarm, a cycle helmet, a programmable point of sale loudspeaker, white goods, a car horn, a musical instrument, an electronic musical box, a chiming or talking clock or watch, a door chime, an integrated loudspeaker, a portable personal audio system, an underwater PA, a home audio device or TV. Alternatively, the device may be a room or building and the vibration component may be a wall, floor or window. The device may be a system for communication with a diver and the vibration component may be an oil rig leg against which a diver's helmet may be placed for structure borne sound conduction.

The operative frequency range may be ultrasonic. The device may be an ultrasonic personnel location device, a system for repelling insects and animals, an ultrasonic motion sensor or other security sensor. The sensor may be formed by exciting a component in an everyday object such as a clock or watch. The sensor may be multifunctional.

The device may be a machine which comprises a mechanism having a mechanical action, and the vibration system may be attached to the mechanism to enhance the mechanical action. The machine may be selected from the group consisting of modulated razor blade cutters, cutters, vibration sorters, fluidised beds, washing machines, devices which convert reciprocal to rotating motion, (e.g. motor driving device or ultrasonic ratchet), carpet beaters, harmonic cleaners, vacuum cleaners, chemical reaction tanks, moving mirrors operating to generate light displays or scanners, welders or inkjet printers.

For example, the machine may be an electric razor comprising a razor blade attached to a mechanism which is driven by a motor to provide reciprocating motion of the blade and the vibration system may be attached to the mechanism. This may give a higher efficiency and thus allow the main motor to be run at lower speeds, whilst the vibration system retains overall cutting efficiency.

Other applications are in motor driving devices, ultrasonic ratchets, jacuzzis, telecomms navigation, talking font, printed actuators or communication in a vacuum. Alternatively, the device may generate light displays and the vibration component may be a moveable mirror.

The device may be used for acoustic reflective signalling, creating cavitation, dispersing water from windscreens or windows, or automatic windows cleaning.

The resonant element may be active (e.g. it may be a piezoelectric transducer) and may be in the form of a strip of piezoelectric material. Alternatively, the resonant element may be passive and the transducer may further comprise an active transducer, e.g. an inertial or grounded vibration transducer, actuator or exciter, e.g. moving coil transducer. The active transducer may be a bender or torsional transducer (e.g. of the type taught in International application WO00/13464 or corresponding U.S. patent application Ser. No. 09/384,419). Furthermore, the transducer may comprise a combination of passive and active elements to form a hybrid transducer.

A number of transducer, exciter or actuator mechanisms have been developed to apply a force to a structure, e.g. an acoustic radiator of a loudspeaker. There are various types of these transducer mechanisms, for example moving coil, moving magnet, piezoelectric or magnetostrictive types. Typically, electrodynamic speakers using coil and magnet type transducers lose 99% of their input energy to heat whereas a piezoelectric transducer may lose as little as 1%. Thus, piezoelectric transducers are popular because of their high efficiency.

There are several problems with piezoelectric transducers, for example, they are inherently very stiff, for example comparable to brass foil, and are thus difficult to match to an acoustic radiator, especially to the air. Raising the stiffness of the transducer moves the fundamental resonant mode to a higher frequency. Thus such piezoelectric transducers may be considered to have two operating ranges. The first operating range is below the fundamental resonance of the transducer. This is the “stiffness controlled” range where velocity rises with frequency and the output response usually needs equalisation. This leads to a loss in available efficiency. The second range is the resonance range beyond the stiffness range, which is generally avoided because the resonances are rather fierce.

Moreover, general teaching is to suppress resonances in a transducer, and thus piezoelectric transducers are generally used only used in the frequency range below or at the fundamental resonance of the transducers. Where piezoelectric transducers are used above the fundamental resonance frequency it is necessary to apply damping to suppress resonance peaks.

The problems associated with piezoelectric transducers similarly apply to transducers comprising other “smart” materials, i.e. magnetostrictive, electrostrictive, and electret type materials. Various piezoelectric transducers are also known, for example as described in EP 0993 231A of Shinsei Corporation, EP 0881 856A of Shinsei Corporation, U.S. Pat. No. 4,593,160 of Murata Manufacturing Co. Limited, U.S. Pat. No. 4,401,857 of Sanyo Electric Co Limited, U.S. Pat. No. 4,481,663 of Altec Corporation and UK patent application GB2,166,022A of Sawafuji. However, it is an object of the invention to employ an improved transducer.

The transducer used in the present invention may be considered to be an intendedly modal transducer. The coupler(s) or coupling means may be attached to the resonant element at a position which is beneficial for coupling modal activity of the resonant element to the interface. The parameters, e.g. aspect ratio, bending stiffness, thickness, and geometry, of the resonant element may be selected to enhance the distribution of modes in the resonant element in the operative frequency range. The bending stiffness and thickness of the resonant element may be selected to be isotropic or anisotropic. The variation of bending stiffness and/or thickness may be selected to enhance the distribution of modes in the resonant element. Analysis, e.g. computer simulation using FEA or modelling, may be used to select the parameters.

The distribution may be enhanced by ensuring a first mode of the active element is near to the lowest operating frequency of interest. The distribution may also be enhanced by ensuring a satisfactory, e.g. high, density of modes in the operative frequency range. The density of modes is preferably sufficient for the active element to provide an effective mean average force which is substantially constant with frequency. Good energy transfer may provide beneficial smoothing of modal resonances. Alternatively, or additionally, the distribution of modes may be enhanced by distributing the resonant bending wave modes substantially evenly in frequency, i.e. to smooth peaks in the frequency response caused by “bunching” or clustering of the modes. Such a transducer may thus be known as a distributed mode transducer or DMT.

Such an intendedly modal or distributed mode transducer is described in International patent application WO 01/54450 and U.S. patent application Ser. No. 09/768,002 filed Jan. 24, 2001 and published as US-2001-0033669-A1 (the latter of which is herein incorporated by reference in its entirety).

The transducer may comprise a plurality of resonant elements each having a distribution of modes, the modes of the resonant elements being arranged to interleave in the operative frequency range and thus enhance the distribution of modes in the transducer as a whole device. The resonant elements may have different fundamental frequencies and thus, the parameters, e.g. loading, geometry or bending stiffness of the resonant elements may be different.

The resonant elements may be coupled together by connecting means in any convenient way, e.g. on generally stiff stubs, between the elements. The resonant elements are preferably coupled at coupling points which enhance the modality of the transducer and/or enhance the coupling at the site to which the force is to be applied. Parameters of the connecting means may be selected to enhance the modal distribution in the resonant element. The resonant elements may be arranged in a stack. The coupling points may be axially aligned.

The resonant element may be plate-like or may be curved out of planar. A plate-like resonant element may be formed with slots or discontinuities to form a multi-resonant system. The resonant element may be in the shape of a beam, trapezoidal, hyperelliptical or may be generally disc shaped. Alternatively, the resonant element may be rectangular and may be curved out of the plane of the rectangle about an axis along the short axis of symmetry.

The resonant element may be modal along two substantially normal axes, each axis having an associated fundamental frequency. The ratio of the two fundamental frequencies may be adjusted for best modal distribution, e.g. about 9:7 (˜1.286:1).

As examples, the arrangement of such modal transducer may be any of: a flat piezoelectric disc; a combination of at least two or preferably at least three flat piezoelectric discs; two coincident piezoelectric beams; a combination of multiple coincident piezoelectric beams; a curved piezoelectric plate; a combination of multiple curved piezoelectric plates or two coincident curved piezoelectric beams.

The interleaving of the distribution of the modes in each resonant element may be enhanced by optimising the frequency ratio of the resonant elements, namely the ratio of the frequencies of each fundamental resonance of each resonant element. Thus, the parameter of each resonant element relative to one another may be altered to enhance the overall modal distribution of the transducer.

When using two active resonant elements in the form of beams, the two beams may have a frequency ratio (i.e. ratio of fundamental frequency) of about 1.27:1. For a transducer comprising three beams, the frequency ratio may be about 1.315:1.147:1. For a transducer comprising two discs, the frequency ratio may be about 1.1 +/−0.02 to 1 to optimise high order modal density or may be about 3.2 to 1 to optimise low order modal density. For a transducer comprising three discs, the frequency ratio may be about 3.03:1.63:1 or may be about 8.19:3.20:1.

The parameters of the coupler(s) or coupling means may be selected to enhance the distribution of modes in the resonant element in the operative frequency range. The coupler means may be vestigial, e.g. a controlled layer of adhesive.

The coupler means may be positioned asymmetrically with respect to the panel so that the transducer is coupled asymmetrically. The asymmetry may be achieved in several ways, for example by adjusting the position or orientation of the transducer with respect to axes of symmetry in the panel or the transducer.

The coupler may form a line of attachment. Alternatively, the coupler may form a point or small local area of attachment where the area of attachment is small in relation to the size of the resonant element. The coupler may be in the form of a stub and have a small diameter, e.g. about 3 to 4 mm. The coupler means may be low mass.

The coupler means may comprise more than one coupling point and may comprise a combination of points and/or lines of attachment. For example, two points or small local areas of attachment may be used, one positioned near centre and one positioned at the edge of the active element. This may be useful for plate-like transducers which are generally stiff and have high natural resonance frequencies.

Alternatively only a single coupling point may be provided. This may provide the benefit, in the case of a multi-resonant element array, that the output of all the resonant elements is summed through the single coupler so that it is not necessary for the output to be summed by the load. The coupler may be chosen to be located at an anti-node on the resonant element and may be chosen to deliver a constant average force with frequency. The coupler may be positioned away from the centre of the resonant element.

The position and/or the orientation of the line of attachment may be chosen to optimise the modal density of the resonant element. The line of attachment is preferably not coincident with a line of symmetry of the resonant element. For example, for a rectangular resonant element, the line of attachment may be offset from the short axis of symmetry (or centre line) of the resonant element. The line of attachment may have an orientation which is not parallel to a symmetry axis of the panel.

The shape of the resonant element may be selected to provide an off-centre line of attachment which is generally at the centre of mass of the resonant element. One advantage of this embodiment is that the transducer is attached at its centre of mass and thus there is no inertial imbalance. This may be achieved by an asymmetric shaped resonant element which may be in the shape of a trapezium or trapezoid.

For a transducer comprising a beam-like or generally rectangular resonant element, the line of attachment may extend across the width of the resonant element. The area of the resonant element may be small relative to that of the vibrating component.

The vibrating component may be in the form of a panel. The panel may be flat and may be lightweight. The material of the vibrating component may be anisotropic or isotropic.

The vibrating component may be capable of supporting bending wave vibration, particularly resonant bending wave mode vibration. The properties of the vibrating component may be chosen to distribute the resonant bending wave modes substantially evenly in frequency, i.e. to smooth peaks in the frequency response caused by “bunching” or clustering of the modes. In particular, the properties of the vibrating component may be chosen to distribute the lower frequency resonant bending wave modes substantially evenly in frequency. The lower frequency resonant bending wave modes are preferably the ten to twenty lowest frequency resonant bending wave modes of the vibrating component.

The transducer location may be chosen to couple substantially evenly to the resonant bending wave modes in the vibrating component, in particular to lower frequency resonant bending wave modes. In other words, the transducer may be mounted at a location where the number of vibrationally active resonance anti-nodes in the acoustic radiator is relatively high and conversely the number of resonance nodes is relatively low. Any such location may be used, but the most convenient locations are the near-central locations between 38% to 62% along each of the length and width axes of the acoustic radiator, but off-centre. Specific or preferential locations are at about 3/7, about 4/9 or about 5/13 of the distance along the axes; a different ratio for the length axis and the width axis is preferred. Preferred is about 4/9 length and about 3/7 width of an isotropic panel having an aspect ratio of about 1:1.13 or about 1:1.41.

The operative frequency range may be over a relatively broad frequency range and may be in the audio range and/or ultrasonic range. There may also be applications for sonar and sound ranging and imaging where a wider bandwidth and/or higher possible power will be useful by virtue of distributed mode transducer operation. Thus, operation over a range greater than the range defined by a single dominant, natural resonance of the transducer may be achieved.

The lowest frequency in the operative frequency range is preferably above a predetermined lower limit which is about the fundamental resonance of the transducer.

For example, for a beam-like active resonant element, the force may be taken from the centre of the beam, and may be matched to the mode shape in the vibrating component to which it is attached. In this way, the action and reaction may co-operate to give a constant output with frequency. By connecting the resonant element to the vibrating component at an anti-node of the resonant element, the first resonance of the resonant element may appear to be a low impedance. In this way, the vibrating component should not amplify the resonance of the resonant element.

### BRIEF DESCRIPTION OF DRAWINGS

Examples that embody the best mode for carrying out the invention are described in detail below and are diagrammatically illustrated in the accompanying drawings in which:

FIGS. 1A and 1B are front and cross-sectional views respectively of a prior art personnel location device;

FIGS. 1C and 1D are front and cross-sectional views respectively of a personnel location device according to the present invention;

FIG. 2 is a schematic cross-section of a first ultrasonic motion detector according to the present invention;

FIGS. 3A and 3B are front and cross-sectional views respectively of a second ultrasonic motion detector (in the form of a clock) according to the present invention;

FIG. 4 shows a cross sectional view of a cutter blade from an electric shaver according to the present invention;

FIG. 5 shows a cross sectional view of a fluidised bed according to the present invention;

FIG. 6 shows a cross sectional view of a vibration sorter according to the present invention;

FIGS. 7 and 8 show plan and cross-sectional views of a circular ratchet according to the present invention;

FIG. 9 shows a cross section of a carpet cleaner suction head comprising a beater bar according to the invention;

FIG. 10 shows an isometric view of the beater bar of FIG. 9;

FIG. 11 shows a cross section of a reaction vessel according to the invention;

FIG. 12 shows a cross-sectional view of apparatus for deflecting a light beam from a light source;

FIG. 13 shows a cross section through an ultrasonic welding head according to the invention;

FIG. 14 shows a cross section through an inkjet delivery system according to the invention;

FIG. 15 is a cross-section of part of an underwater support structure;

FIG. 16 shows a horn loaded loudspeaker diaphragm for use as an alarm;

FIG. 17 shows a cross-section of part of a panel loudspeaker;

FIGS. 18a and 18b are plan and cross-sectional views of a section of a building;

FIGS. 19a and 19b show respectively perspective and cross-sectional views of a typical domestic appliance;

FIG. 20 shows a cross section through a section of an integrated point of sale panel loudspeaker;

FIG. 21 shows a cross section through a musical box;

FIGS. 22a and 22b are respectively front and cross-sectional views of a window;

FIG. 23 shows a schematic cross-section of a loudspeaker system for repelling for insects and animals;

FIGS. 24 to 30 are side views of modal transducers according to the present invention;

FIG. 31 is a plan view of an alternative modal transducer according to in the present invention;

FIG. 32A is a schematic plan view of a parameterised model of a transducer according to the present invention;

FIG. 32B is a section perpendicular to the line of attachment of the transducer of FIG. 32A; and

FIG. 33 is a schematic plan view of a parameterised model of a transducer according to the present invention.

### DETAILED DESCRIPTION

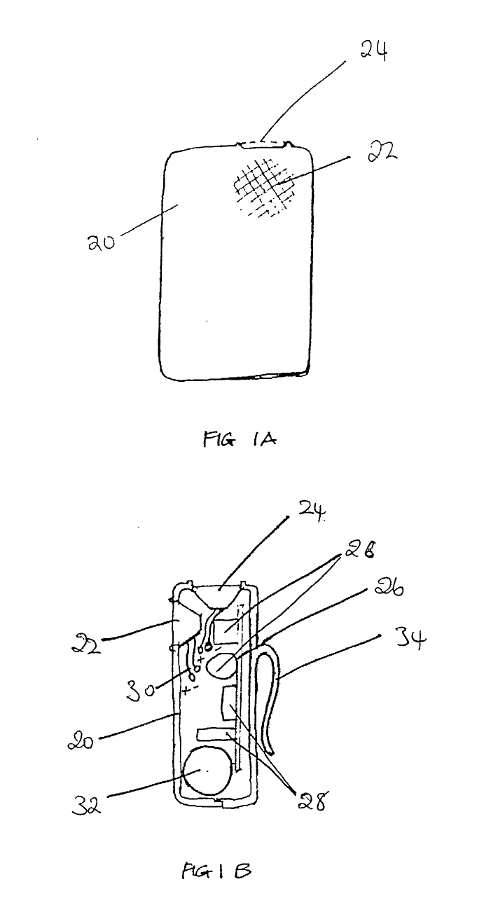

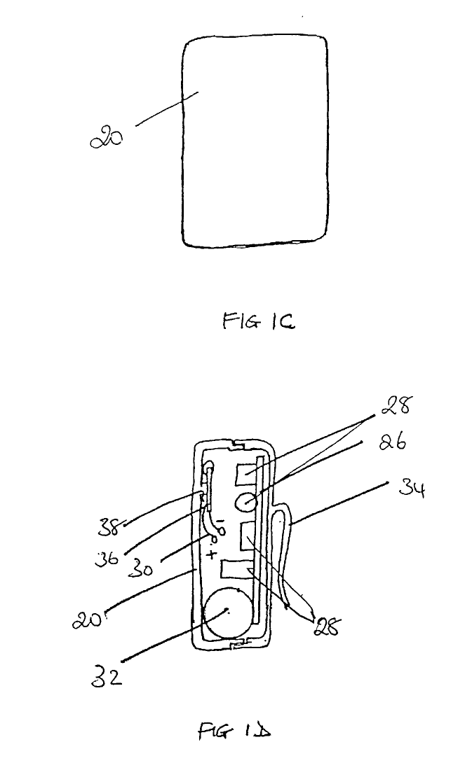

FIGS. 1C and 1D show a personnel location device according to the present invention which in contrast to the prior art personnel location device has no external acoustic apertures. The device comprises a case (20) to which is attached a transducer (36) by a stub (38) to drive the case (20) to produce ultrasonic output. The transducer (36) is an intendedly modal transducer or distributed mode transducer as hereinbefore described and as described in WO 01/54450 and U.S. patent application Ser. No. 09/768,002. By matching the mechanical impedance of the transducer to that of the case a high coupling efficiency is achieved. This efficiency makes the application sufficiently sensitive to need only a single transducer in contrast to the prior art device. The stub (38) may be part of the case moulding.

The case also houses a circuit board (26) having components (28) which drive the transducer by way of wires (30). The device is portable since it is powered by a battery (32) and a clip (34) is attached to the case (20) which allows the device to be fixed to a convenient position on a user's clothing.

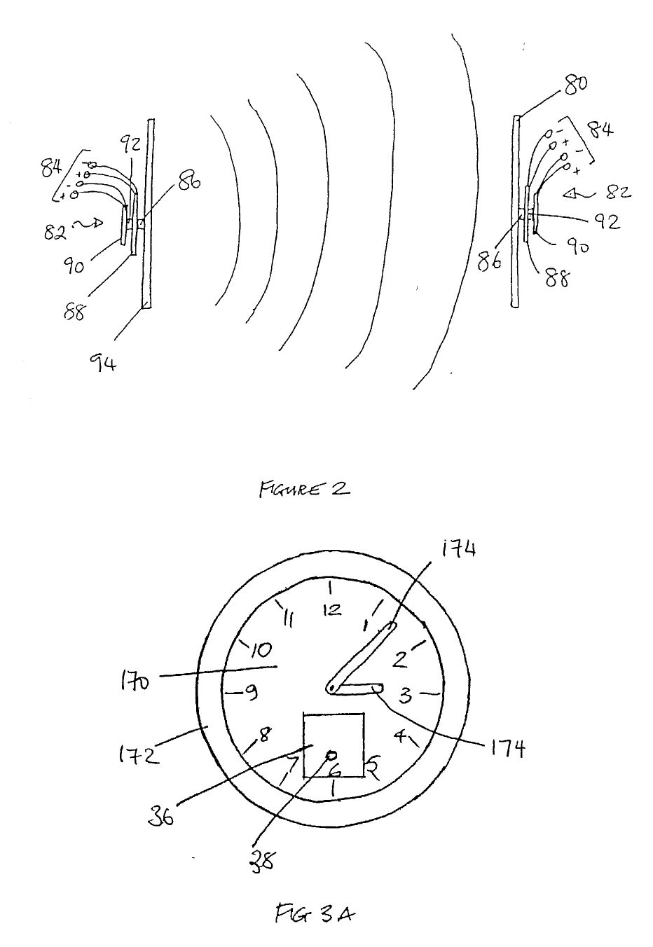

FIG. 2 shows an ultrasonic motion detector comprising a transmitter and a receiver. The transmitter comprises a transmitting panel (94) which is driven by a transducer (82) to produce radiated ultrasonic sound. The transducer (82) is an intendedly modal transducer or distributed mode transducer as hereinbefore described and as described in WO 01/54450 and U.S. patent application Ser. No. 09/768,002. The transducer (82) comprises a first beam (88) which is mounted to the panel (94) by a stub (86). A second beam (90) is fixed to the first beam (88) by a connecting stub (92). Electrical connections are made by way of wires (84).

As shown in FIG. 2, the radiated sound is detected by a receiver which comprises a receiving panel (80) which is acting as a microphone and drives a second transducer (82). The second transducer (82) is identical to that on the transmitting panel (94) and thus the features in common have the same reference numbers. Alternatively, the radiated sound may be detected by a conventional ultrasonic microphone.

Any object that is placed in between the transmitter and receiver will change the level of the signal detected, and the resulting signals can be used to trigger an audible alarm device (not shown).

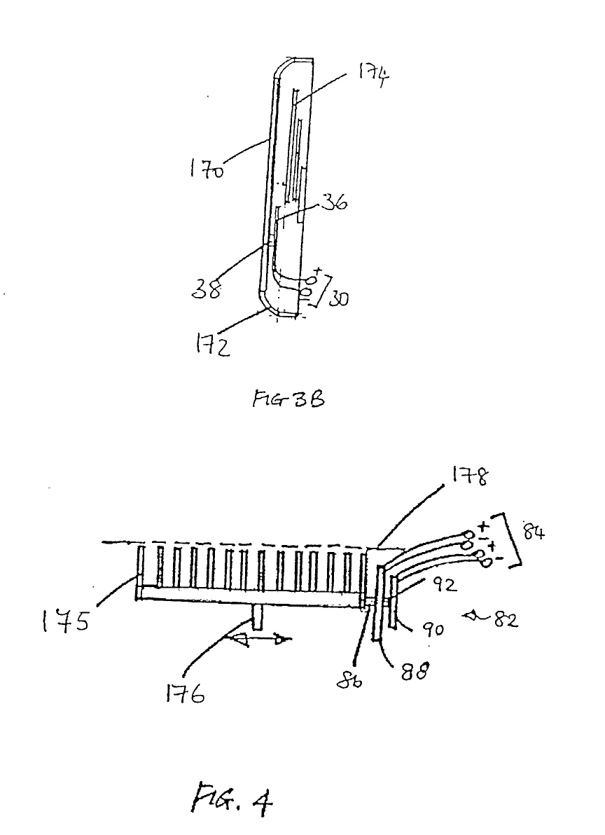

FIGS. 3A and 3B show a clock comprising a case (172), a clear front window (170) and hands (174) which point to the current time and which are visible through the window. A modal transducer (36), similar to that shown in FIGS. 1C and 1D, is attached to the window (170) by a stub (38).

The transducer (36) is in the form of a plate and is designed so as not to obstruct a view of the hands (174). The transducer may thus be made from transparent piezoelectric material, or may be made small enough not to be obtrusive. The connections to the transducer (36) are via wires (30).

The transducer (36) drives the window (170) to produce an ultrasonic signal so that the window (170) acts as a transmitter. The signal will normally be reflected from surrounding structures, and a stable sound field will exist. Additionally, the window (170) may act as a receiver for such reflected ultrasonic signals. Any alteration in the stable sound field may be used to detect an intruder and thus a common found object such as a clock may be modified to act as ultrasonic motion detector. Deployment of such detectors may thus be both covert and convenient. Furthermore, the frequency of the sound field may be tuned, so as to optimise the detection sensitivity for the particular location being guarded.

Alternatively, the signal may be in the audible band to form a chiming or talking clock. This may be extended to watches or door chimes.

FIG. 4 shows a cross sectional view of a cutter blade (175) from an electric shaver. The cutter blade (175) is driven so as to oscillate across a fixed perforate foil (178) in order to cut a protruding hair. The oscillation or reciprocating action is delivered by a lower peg (176) in a conventional known manner.

A modal transducer (82) like that in FIG. 2 is attached to the oscillating blades by way of a stub (86) and elements in common have the same reference numbers. The transducer (82) generates vibration in the blade (175). By vibrating the blade at a range of frequencies, whilst the blade is being driven back and forth, the cutting performance will be enhanced by the combination of reciprocating and vibrating motions. Furthermore, the low weight of the transducer means that the normal reciprocating motion of the blades is largely unaffected.

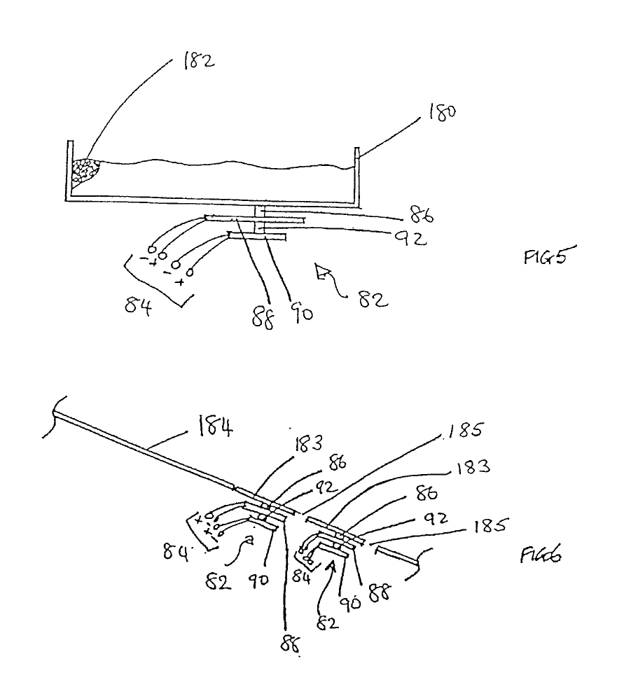

FIG. 5 shows a fluidised bed (180) containing particles (182). A two-beam modal transducer (82) like that in FIG. 2 is attached to the fluidised bed (180) by way of a stub (86) and elements in common have the same reference numbers. The transducer (82) generates vibration in the fluidised bed (180) whereby the particles are held partly in suspension.

FIG. 6 shows a vibration sorter comprising a delivery guide (184) down which items are delivered for sorting and a sorter bed. The bed comprises a series of active platforms (183) each followed by a respective apertures (185) having dimensions which are designed to accept particular items. Each of the platforms (185) is driven by a two-beam modal transducer (82) like that in FIG. 2 and elements in common have the same reference numbers.

Each transducer may deliver mechanical power over a wide bandwidth and thus the vibration of each platform may be tuned and re-tuned in frequency to match the items being sorted. The vibration of the platform will be transmitted to items being sorted. If an item having a particular weight is to be rejected, the frequency of the vibration may be selected to cause only items with such a weight to jump over the apertures (185). Thus the transducer (82) provides a tuneable sorter. Further, the transducer operates at high efficiency.

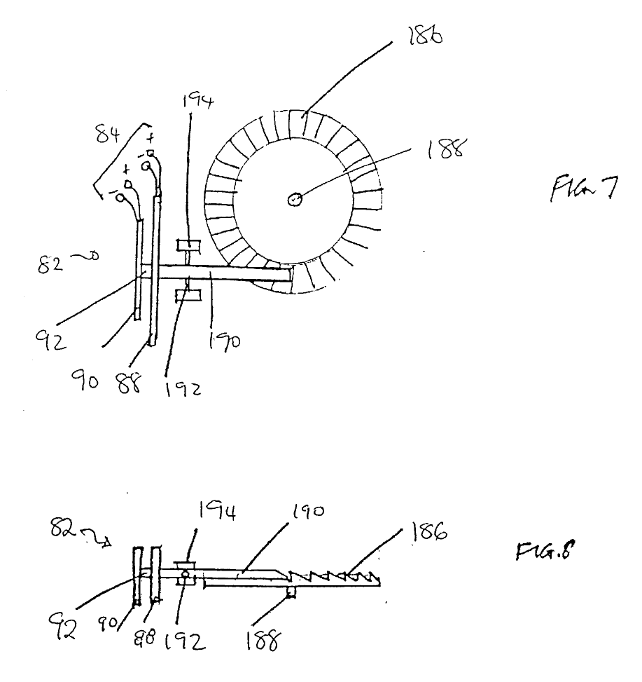

FIGS. 7 and 8 show a circular ratchet (186), which is rotated in a counter-clockwise direction about a shaft or axle (188) by an actuating arm (190). The axle is held in a suitable bearing (not shown). The actuating arm (190) and hence the circular ratchet is driven by a two-beam modal transducer (82) like that in FIG. 2 and elements in common have the same reference numbers.

The actuating arm (190) is held in a resilient suspension (192) against a fixed mounting (194). The suspension (192) allows both the transducer and the actuating arm to oscillate back and forth. The suspension may be attached to the second beam (90) of the transducer (82) and may be aligned with the connecting stub (92). By varying the drive frequency, the motor can be made to have variable speed.

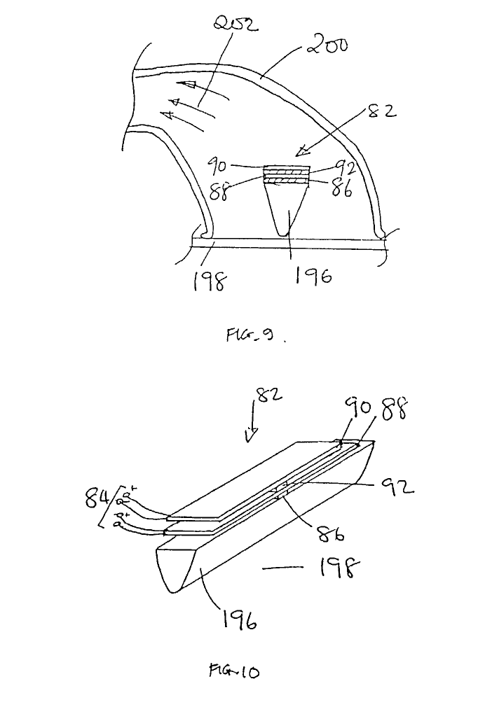

FIGS. 9 and 10 show a carpet cleaner suction head comprising a beater bar (196) which in use rests on a carpet surface (198). The beater bar (196) is suspended by rubber bushes, or the like, at each end (not shown). The beater bar (196) is driven into vibration by a two-beam modal transducer (82) like that in FIG. 2 and elements in common have the same reference numbers. A hood (200) is connected to a suction pump (not shown) and the hood is used to create a partial vacuum. Thus, particles driven from the carpet by vibration of the beater bar (196) are drawn up in the direction of arrows (202) into the hood (200) and directed toward a receiving bag (not shown). A variable generator signal adjusts the frequency of the vibration to suit the condition of the carpet surface and the nature of the particles to be lifted from the carpet.

FIG. 11 shows a cross section of a reaction vessel (204) containing chemicals (206) undergoing a reaction. The reaction vessel is agitated by a two-beam modal transducer (82) like that in FIG. 2 and elements in common have the same reference numbers. The agitation may provide improved chemical reactions. Since the transducer may be operated over a wide bandwidth, the driving frequency may be set at a single preferential frequency. Alternatively, a number of frequencies or bandwidths can be used to improve the reaction.

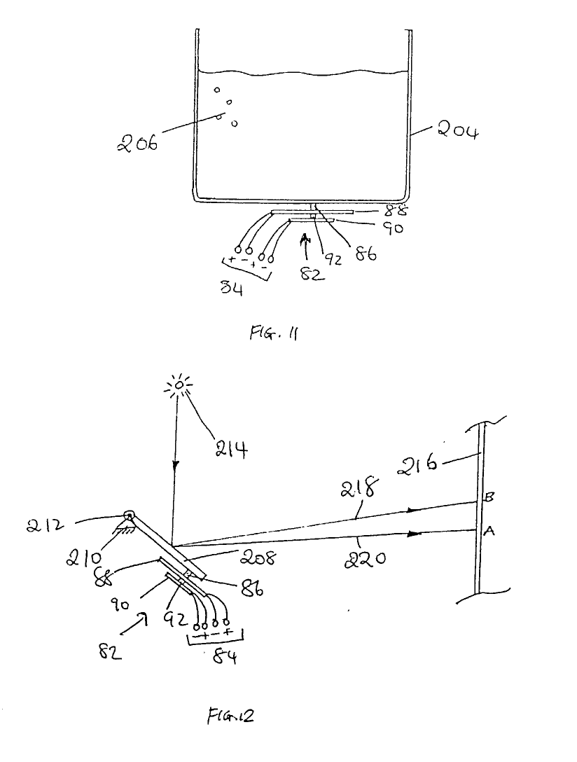

FIG. 12 shows apparatus for deflecting a light beam from a light source (214). The apparatus comprises a mirror (208) suspended on a support (210), for example a pivot is held in a bearing, fixed to a rigid support (212) and a receiving plane (216) which may be a viewing screen. The light beam is directed to the mirror (208) and reflected light is directed along a first path (218) to a location (B) in the receiving plane. A two-beam modal transducer (82) like that in FIG. 2 is fixed to the mirror (208) and elements in common have the same reference numbers. The transducer (82) is adapted to deflect the mirror (208) and re-align the reflected light along a second path (220) to a second position (A) in the receiving plane.

FIG. 13 shows an ultrasonic welding head (222) which may be used to weld two components (224,226) together. The components (224,226) are supported on a base (228). The welding head is driven by a two-beam modal transducer (82) like that in FIG. 2 and elements in common have the same reference numbers. Electrical connections are made via wires (84), to a generator (not shown), which may deliver a variable frequency, or combinations of frequencies, selected to match the head and materials to be welded. In contrast, traditional ultrasonic welders are designed to operate at a single chosen frequency, determined by the application and, thus, different heads may be needed for different applications.

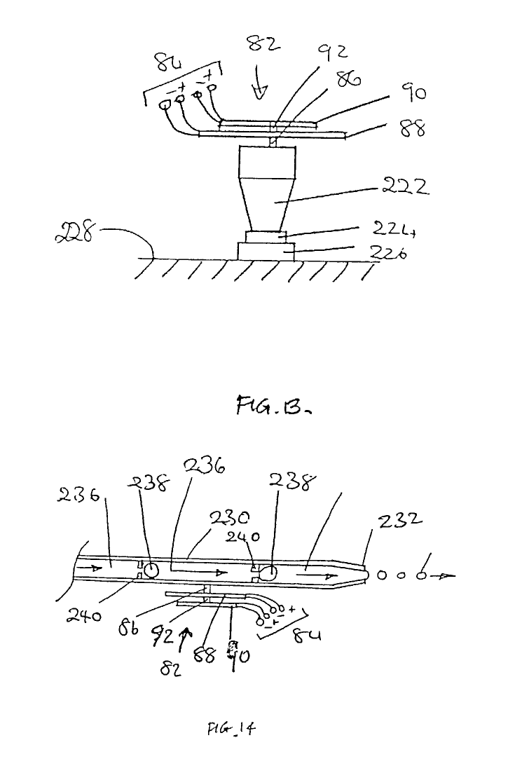

FIG. 14 shows a cross section through an inkjet delivery system which comprises a main tube (230) which is constricted at one end to form a nozzle (232) and is connected to a reservoir (not shown) at the opposed end. The main tube is driven by a two-beam modal transducer (82) like that in FIG. 2 and elements in common have the same reference numbers. The tube (230) has a wall which is sufficiently flexible so as to be deflected by the transducer (82) and may be locally thinned to form a flexible section. The action of the transducer (82) may be regarded as push-pull to produce respectively inward and outward deflection of the main tube which respectively causes compression and decompression in an inner chamber (236) of the main tube.

Decompression of the inner chamber causes ink to be drawn from the reservoir into the inner chamber (236). Non-return valves (238) sit on seats (240) to only allow ink to travel towards the nozzle (232). Compression of the inner chamber causes the ink to be pumped out towards the nozzle (232). Wires (84) connect the transducer (82) to a signal generator (not shown) to provide the necessary waveform to generate the alternate compression and decompression or rarefaction of the ink. The high mechanical efficiency and wide operating bandwidth means that the inkjet quantity and delivery rate may both be varied to suit any application.

FIG. 15 shows part of an underwater support structure (242) which is driven by a two-beam modal transducer (82) like that in FIG. 2 and elements in common have the same reference numbers. Electrical connections are made through wires (84), which are embedded in a flexible rubber layer to prevent the ingress of water. The transducer (82) drives the support structure (242) so as to produce an audible signal in a diver's helmet (244) an outer surface of which is pressed against the support structure (242), thus allowing communication with the diver. The helmet (244) has a visor (246). The transducer (82) may be designed to match the support structure to give high mechanical efficiency, which in turn will couple to the outer face of the diver's helmet.

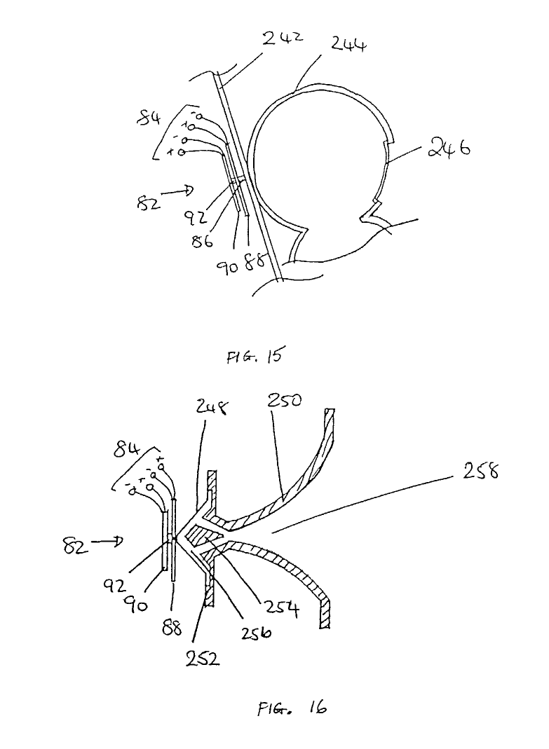

FIG. 16 shows a loudspeaker diaphragm (248) which is of a lightweight paper or plastics material and which is suspended around its periphery onto the body of a horn (250). The suspension forms an airtight seal between the front face of the diaphragm (248) and the rear flange (252) of the horn (250). A phase plug (254) which loads the diaphragm is suspended so as to leave a small air gap between the diaphragm and the phase plug (252). An annular opening (256) between the phase plug (254) and horn mouth (258) allows pressure to be delivered into the horn mouth (258).

The diaphragm (248) is made to vibrate in a generally axial motion by a transducer (82) which is connected to the apex of the diaphragm. The transducer (82) is a two-beam modal transducer (82) like that in FIG. 2 and elements in common have the same reference numbers. The transducer may be matched to the mechanical impedance presented by the combination of horn and lightweight diaphragm, which may be arranged to be substantially resistive. Thus, there is a synergistic relationship between the action of the horn on a simple diaphragm and the matching requirements for the transducer (82). In this way, a high efficiency of mechanical power transfer and an improved output from the horn in terms of efficiency and bandwidth may be achieved. The system may be used, for example, as a dog whistle, a smoke alarm, a rape alarm, a car horn, and of course, a loudspeaker.

FIG. 17 shows part of a panel loudspeaker which comprises a panel (260) which is capable of supporting resonant bending wave vibration and a conventional moving coil exciter (262) for exciting vibration in the panel (260). The panel (260) may be a distributed mode panel as taught in International application WO 97/09842 and corresponding U.S. Pat. No. 6,332,029 granted Dec. 12, 2001 and others of the present applicant. The exciter (262) is connected by wires (264) to a signal source via an amplifier (not shown). Generally, such conventional moving coil exciters have the disadvantage that the high frequency extension is limited by the coil mass and diameter of the voice-coil used. Hence such exciters may have limited output at high frequencies.

A two-beam modal transducer (82) is mounted to the panel (260) at a different location to that of the first exciter (262). The transducer (82) is like that in FIG. 2 and elements in common have the same reference numbers. By adding such a transducer (82) to the panel, a high coupling efficiency and hence generation of high frequencies may be achieved. Electrical connections are made via wires (84), to an amplifier (not shown). The additional of suitable filters in the drive circuits for both the exciter (262) and transducer (82) will ensure proper integration of the signals to cover the whole frequency range.

The addition of the modal transducer (82) provides an easy, low cost method for extending the panel high frequency response. Thus, an improved Distributed mode loudspeaker, (DML) may be provided by adding a modal transducer (82) to a panel (260), which already has at least one conventional exciter present.

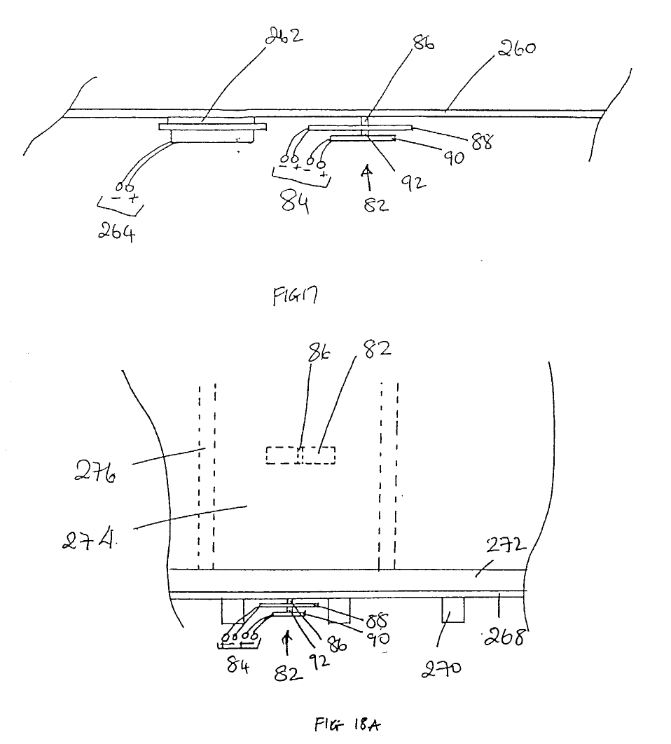

FIGS. 18a and 18b show a section of a building comprising a suspended floor (268) sitting on joists (270) and an adjacent wall (274), which has an optional skirting board (272). The floor is driven by a two-beam modal transducer (82) like that in FIG. 2 and elements in common have the same reference numbers. The transducer (82) is fixed to the floor (268) by way of a stub (86) so as to excite vibration in the floor (268) to produce an acoustic output. Similarly the wall (274), which may be plasterboard or the like and which may be mounted on supports (276), may also be driven to produce an acoustic output by a modal transducer (82). The electrical connections to both transducers are taken by wires (84), to an amplifier (not shown).

Matching the mechanical impedance of the transducer (82) to the floor (268) or wall (274) can ensure a high coupling efficiency. Thus, a simple method and installation for reproducing audible sounds in a building is provided.

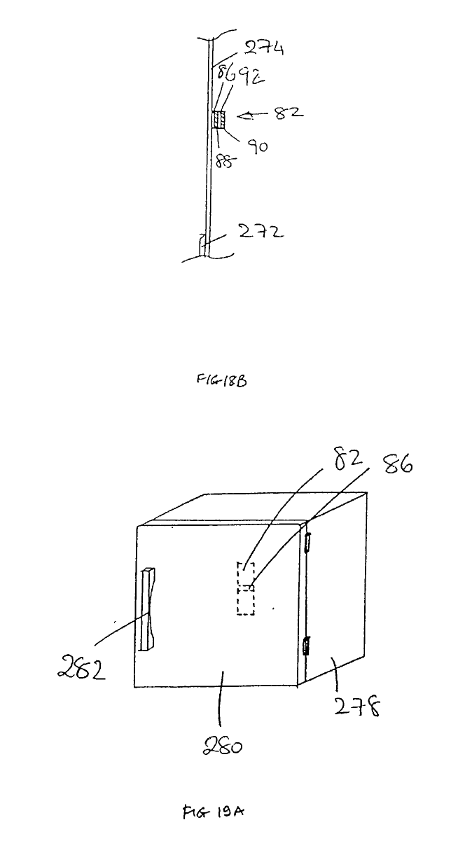

FIGS. 19a and 19b show a typical domestic appliance, for which reproduced sound is required. The appliance comprises a main unit (278), a door (280) and a door handle (282). The door (280) is sealed to the main unit (278) by a door seal (284) which provides some isolation of any door vibration from the main appliance body. This is essential if the appliance is particularly sensitive to vibrations. The door material can be thin metal (usually steel or the like), or a plastic moulded part.

The door (280) is driven by a two-beam modal transducer (82) like that in FIG. 2 and elements in common have the same reference numbers. The transducer (82) is fixed to the door (280) by way of a stub (86) so as to excite vibration in the door to produce an acoustic output. This method prevents the need for a loudspeaker diaphragm which may be unhygienic in a food preparation area, or other area that needs to be sterile, for example in a hospital or similar workplace. The reproduced sound may be speech, alarms, or other audio content, depending on the application.

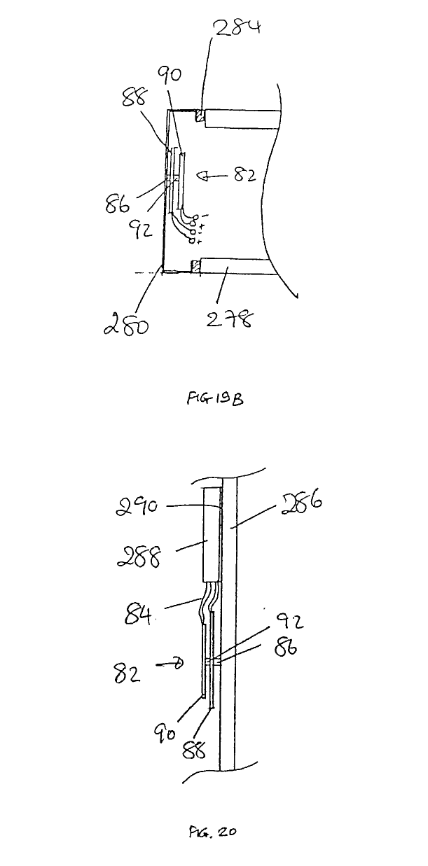

FIG. 20 shows part of a point-of-sale (POS) loudspeaker which comprises a panel (286) which is driven by a two-beam modal transducer (82) like that in FIG. 2 and elements in common have the same reference numbers. The transducer (82) is fixed to the panel (286) by way of a stub (86) so as to excite vibration in the panel (286) to produce an acoustic output. The transducer (82) is connected to an amplifier module (288) by wires (84). The amplifier module (288) is fixed to the panel (286) by way of a suitable adhesive layer (290). The amplifier module (288) may comprise an amplifier, a battery and a programmable device capable of storing and replaying audio signals to the amplifier.

A high coupling efficiency may be achieved by matching the transducer mechanical impedance to the panel (286) and thus the battery life may be extended.

FIG. 21 shows a cross section through a musical box which comprises a main case (292), a lid (294) and a switch (296) which is operated by the lid (294) to activate the musical box when opened. A dividing shelf within the main case (292) forms an acoustic radiator (298) or sounding board. The acoustic radiator (298) is driven by a two-beam modal transducer (82) like that in FIG. 2 and elements in common have the same reference numbers. Wires (84) can make electrical connections from the transducer (82) to an amplifier mounted on the circuit board (300). The circuit board (300) also holds a battery (302) and a programmable device capable of storing and replaying audio signals to the amplifier.

A high coupling efficiency may be achieved by matching the mechanical impedance of the transducer (82) to the shelf and hence the battery life of the musical box may be extended. The musical box may play any number of different tunes.

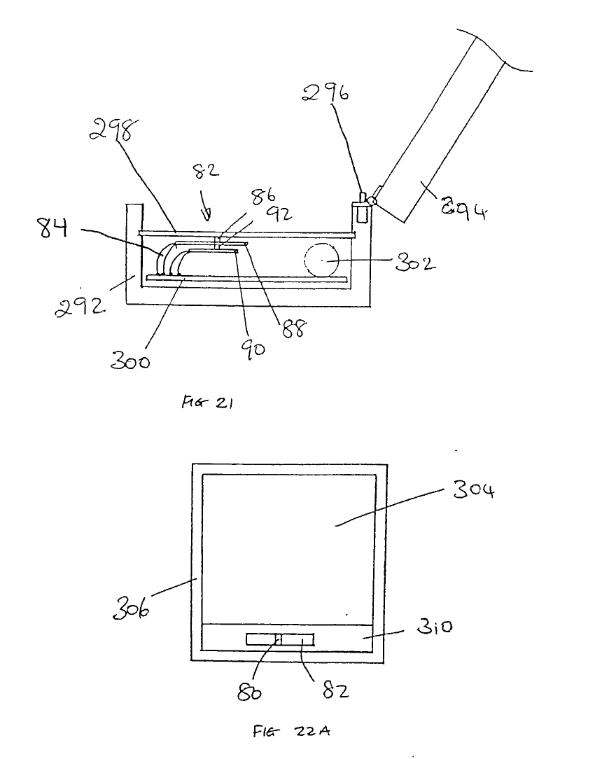

FIGS. 22a and 22b show a window (304) which is mounted in a frame (306) by a compliant seal (308). The window (304) is driven by a two-beam modal transducer (82) like that in FIG. 2 and elements in common have the same reference numbers. The transducer (82) is connected to the window (304) by a stub (86). An optional mask (310) is used to obscure the transducer (82) from an external observer. The transducer (82) may be a high efficiency, broad band transducer. By vibration of the window (304) (or windscreen with an appropriate signal), surface tension of any liquid on the window is reduced, thus the liquid is dispersed and runs off the window.

FIG. 23 shows a loudspeaker system which emits certain audible and ultrasonic signals to repel insects and animals. The system comprises a panel (312) adapted to radiate sound which is driven by a two-beam modal transducer (82) like that in FIG. 2 and elements in common have the same reference numbers. The transducer (82) is connected by wires (84) to an amplifier (314). The amplifier (314) is driven by a signal generator (318), by way of a tuneable filter (316).

The combination of signal generator (318) and tuneable filter (316) may be set to deliver any desired signal to the transducer (82), which operates as a wide bandwidth, high efficiency transducer to generate sound from the panel (312). Thus, the device may be tuneable for different animals and/or insects. In contrast, using conventional technology it may be necessary to have different devices for different insects/animals because the frequencies transmitted often have narrow frequency bands.

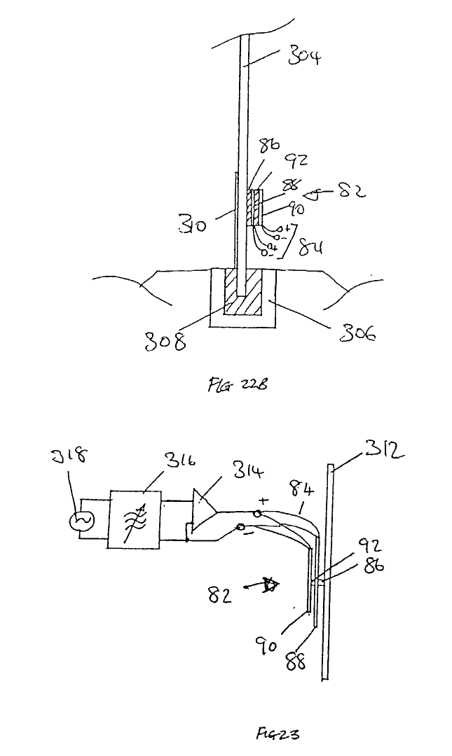

FIGS. 24 to 33 show a variety of transducers which are designed to operate over a broad bandwidth and are designed to be mounted to produce vibration in the many applications listed above.

FIG. 24 shows a transducer (42) which comprises a first piezoelectric beam (43) on the back of which is mounted a second piezoelectric beam (51) by connecting means in the form of a stub (48) located at the centre of both beams (43, 51). Each beam (43, 51) is a bi-morph. The first beam (43) comprises two layers (44,46) of piezoelectric material and the second beam (51) comprises two layers (50,52). The poling directions of each layer of piezoelectric material are shown by arrows (49). Each layer (44, 50) has an opposite poling direction to the layers (46, 52), respectively, in the bi-morph. The bimorph may also comprise a central conducting vane which allows a parallel electrical connection as well as adding strengthening component to the ceramic piezoelectric layers. Each layer of each beam (43, 51) may be made of the same/different piezoelectric material. Each layer is generally of a different length.

The first piezoelectric beam (43) is mounted on a panel (54) by a coupler or coupling means in the form of a stub (56) located at the centre of the first beam (43). By mounting the first beam (43) at its centre only the even order modes will produce output. By locating the second beam (51) behind the first beam (43), and coupling both beams centrally by way of a stub (48) they can both be considered to be driving the same axially aligned or co-incident position.

When beams (43, 51) are joined together, the resulting distribution of modes is not the sum of the separate sets of frequencies, because each beam modifies the modes of the other. The two beams (43, 51) are designed so that their individual modal distributions are interleaved to enhance the overall modality of the transducer (42). The two beams (43, 51) add together to produce a useable output over a frequency range of interest. Local narrow dips occur because of the interaction between the piezoelectric beams (43, 51) at their individual even order modes.

The second beam may be chosen by using the ratio of the fundamental resonance of the two beams. If the materials and thicknesses are identical, then the ratio of frequencies is just the square of the ratio of lengths. If the higher f0 (fundamental frequency) is simply placed half way between f0 and f1 of the other, larger beam, f3 of the smaller beam and f4 of the lower beam coincide.

Plotting a graph of a cost function against the ratio of the frequency for two beams shows that the ideal ratio is about 1.27:1, namely where the cost function is minimised at point. This ratio is equivalent to the “golden” aspect ratio (i.e., a ratio of about f02:f20) described in WO97/09842 and corresponding U.S. Pat. No. 6,332,029 granted Dec. 12, 2001. The method of improving the modality of a transducer may be extended by using three piezoelectric beams in the transducer. The ideal ratio is about 1.315:1.147:1.

The method of combining active elements, e.g. beams, may be extended to using piezoelectric discs. Using two discs, the ratio of sizes of the two discs depends upon how many modes are taken into consideration. For high order modal density, a ratio of fundamental frequencies of about 1.1 +/−0.02 to 1 may give good results. For low order modal density (i.e. the first few or first five modes), a ratio of fundamental frequencies of about 3.2:1 is good. The first gap comes between the second and third modes of the larger disc.

Since there is a large gap between the first and second radial modes in each disc, much better interleaving is achieved with three rather than with two discs. When adding a third disc to the double disc transducer, the obvious first target is to plug the gap between the second and third modes of the larger disc of the previous case. However, geometric progression shows that this is not the only solution. Using fundamental frequencies of f0, α.f0 and α^{2.}f0, and plotting rms (α,α²) there exist two principal optima for α. The values are about 1.72 and 2.90, with the latter value corresponding to the obvious gap-filling method.

Using fundamental frequencies of f0, α.f0 and β.f0 so that both scalings are free and using the above values of α as seed values, slightly better optima may be achieved. The parameter pairs (α,β) are (1.63, 3.03) and (3.20, 8.19). These optima are quite shallow, meaning that variations of 10%, or even 20%, in the parameter values are acceptable.

An alternative approach for determining the different discs to be combined is to consider the cost as a function of the ratio of the radii of the three discs. The cost functions may be RSCD (ratio of sum of central differences), SRCD (sum of the ratio of central differences) and SCR (sum of central ratios). For a set of modal frequencies, f₀, f₁, fₙ, . . . f_{N}, these functions are defined as:

$$\begin{matrix} RSCD ( R sum CD ) \text{:} \\ RSCD = \frac{\frac{1}{N - 1} {\sum }_{n = 1}^{N - 1} {( {f}_{n + 1} + {f}_{n - 1} - 2 {f}_{n} )}^{2}}{{f}_{0}} \\ SCRD ( sum RCD ) \text{:} \\ SCRD = \frac{1}{N - 1} {\sum }_{n = 1}^{N - 1} {( \frac{{f}_{n + 1} + {f}_{n - 1} - 2 {f}_{n}}{{f}_{n}} )}^{2} \\ CR \text{:} \\ SCR = \frac{1}{N - 1} {\sum }_{n = 1}^{N - 1} ( \frac{{f}_{n + 1} \cdot {f}_{n - 1}}{{( {f}_{n} )}^{2}} )\end{matrix}$$

The optimum radii ratio, i.e. where the cost function is minimised, is about 1.3 for all cost functions. Since the square of the radii ratio is equal to the frequency ratio, for these identical material and thickness discs, the results of (1.3)(1.3)=1.69 and the analytical result of 1.67 are in good agreement.

Alternatively or additionally, passive elements may be incorporated into the transducer to improve its overall modality. The active and passive elements may be arranged in a cascade. FIG. 25 shows a multiple disc transducer (70) comprising two active piezoelectric elements (72) stacked with two passive resonant elements (74), e.g. thin metal plates so that the modes of the active and passive elements are interleaved.

The elements are connected by connecting means in the form of stubs (78) located at the centre of each active and passive element. The elements (72, 74) are arranged concentrically. Each element has different dimensions with the smallest and largest discs located at the top and bottom of the stack, respectively. The transducer (70) is mounted on a load device (76), e.g. a panel, by coupling means in the form of a stub (78) located at the centre of the first passive device which is the largest disc.

The method of improving the modality of a transducer may be extended to a transducer comprising two active elements in the form of piezoelectric plates. Two plates of dimensions (1 by α) and (α by α²) are coupled at about (3/7, 4/9). The frequency ratio is, therefore, about 1.3:1 (1.14×1.14=1.2996).

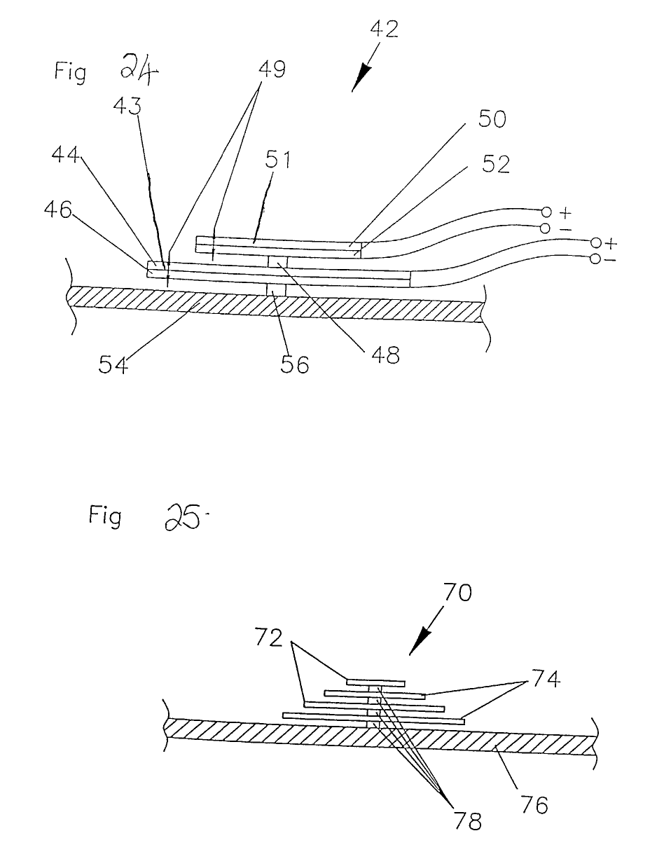

As shown in FIG. 26, small masses (104) may be mounted at the end of the piezoelectric transducer (106) having coupling means (105). In FIG. 27, the transducer (114) is an inertial electrodynamic moving coil exciter, e.g. as described in International application WO97/09842 and corresponding U.S. Pat. No. 6,332,029 granted Dec. 12, 2001, having a voice coil forming an active element (115) and a passive resonant element in the form of a modal plate (118). The active element (115) is mounted on the modal plate (118) and off-centre of the modal plate (118).

The modal plate (118) is mounted on the panel (116) by a coupler (120). The coupler is aligned with the axis (117) of the active element (115) but not with the axis (Z) normal to the plane of the panel (116). Thus the transducer is not coincident with the panel axis (z). The active element (115) is connected to an electrical signal input via electrical wires (122). The modal plate (118) is perforate to reduce the acoustic radiation therefrom and the active element (115) is located off-centre of the modal plate (118), for example, at the optimum mounting position, i.e. about (3/7, 4/9).

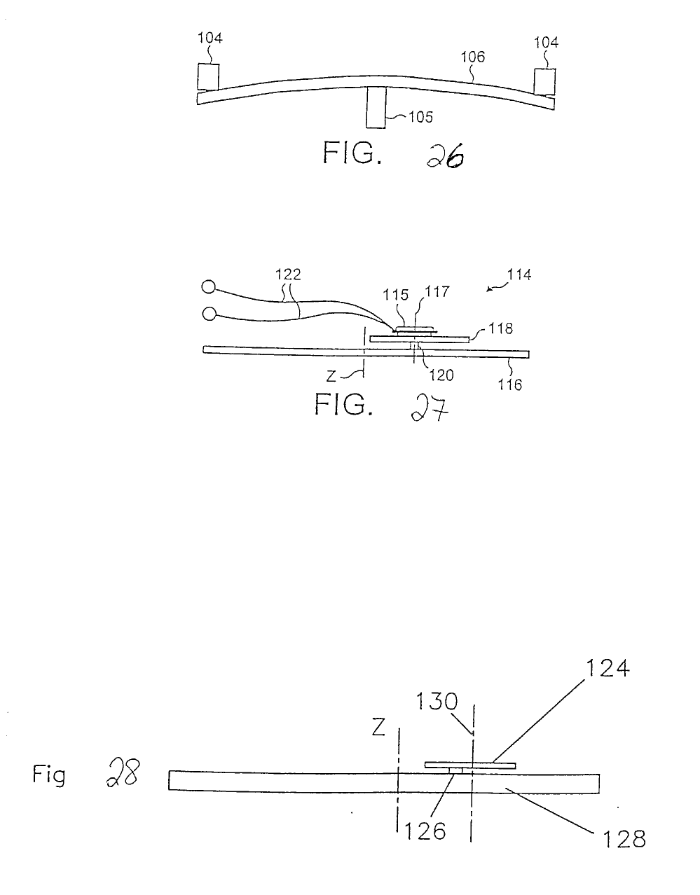

FIG. 28 shows a transducer (124) comprising an active piezoelectric resonant element which is mounted by coupling means (126) in the form of a stub to a panel (128). Both the transducer (124) and panel (128) have ratios of width to length of about 1:1.13. The coupling means (126) is not aligned with any axes (130, Z) of the transducer (124) or the panel (128). Furthermore, the placement of the coupling means (126) is located at the optimum position, i.e. off-centre with respect to both the transducer (124) and the panel (128).

FIG. 29 shows a transducer (132) in the form of active piezoelectric resonant element in the form of a beam. The transducer (132) is coupled to a panel (134) by two coupling means (136) in the form of stubs. One stub is located towards an end (138) of the beam and the other stub is located towards the centre of the beam.

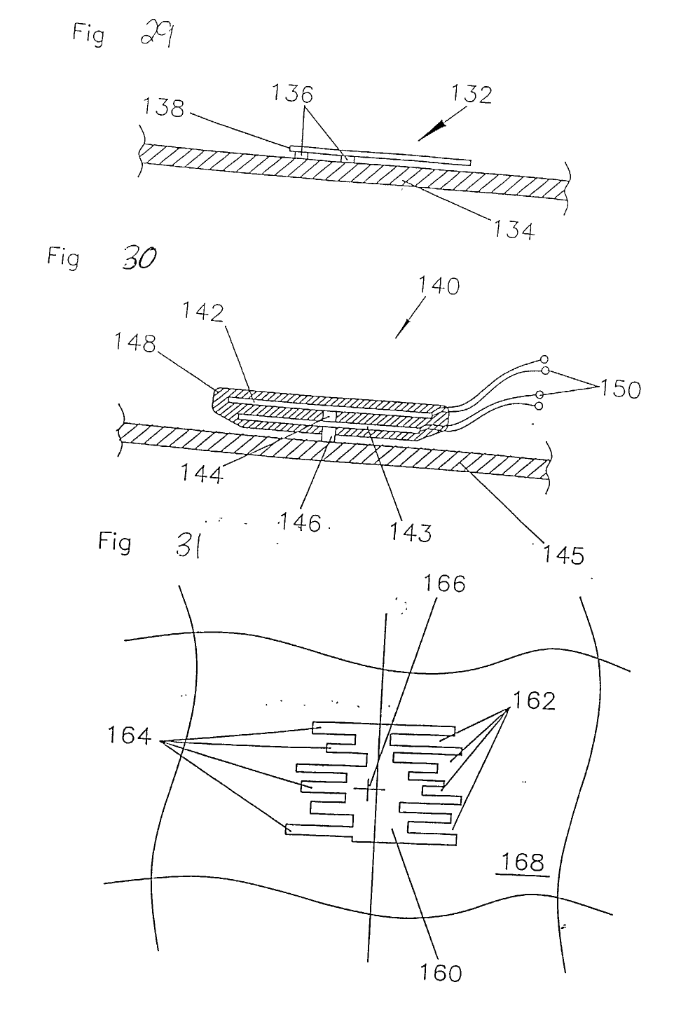

FIG. 30 shows a transducer (140) comprising two active resonant elements (142,143) coupled by a connector or a connecting means (144) and an enclosure (148) which surrounds the connecting means (144) and the resonant elements (142, 143). The transducer (140) is thus made shock and impact resistant. The enclosure (148) is made of a low mechanical impedance rubber or comparable polymer so as not to impede the transducer operation. If the polymer is water resistant, the transducer (140) may be made waterproof.

The upper resonant element (142) is larger than the lower resonant element (143) which is coupled to a panel (145) via a coupling means in the form of a stub (146). The stub (146) is located at the centre of the lower resonant element (143). The power couplings (150) for each active element (142, 143) extend from the enclosure (148) to allow good audio attachment to a load device (not shown).

FIG. 31 shows a transducer (160) in the form of a plate-like active resonant element. The resonant element is formed with slots (162) which define fingers (164) and thus form a multi-resonant system. The resonant element is mounted on a panel (168) by a coupling means in the form of a stub (166).

In FIGS. 32A and 32B, the transducer (14) is rectangular with out-of-plane curvature and is a pre-stressed piezoelectric transducer of the type disclosed in U.S. Pat. No. 5,632,841 (International patent application WO 96/31333) and produced by PAR Technologies Inc. under the trade name NASDRIV. Thus, the transducer (14) is an active resonant element. The transducer has a width (W) and a length (L) and a position (x) defining an attachment point (16).

The curvature of the transducer (14) means that the coupling means (16) is in the form of a line of attachment. When the transducer (14) is mounted along a line of attachment along the short axis through the centre, the resonance frequencies of the two arms of the transducer are coincident. The optimum suspension point may be modelled and has the line of attachment at about 43% to 44% along the length of the resonant element. The cost function (or measure of “badness”) is minimised at this value; this corresponds to an estimate for the attachment point at about 4/9ths of the length (L). Furthermore, computer modelling showed this attachment point to be valid for a range of transducer widths. A second suspension point at about 33% to 34% along the length of the resonant element also appears suitable.

By plotting a graph of cost (or rms central ratio) against aspect ratio (AR=W/2L) for a resonant element mounted at about 44% along its length, the optimum aspect ratio may be determined to be about 1.06 +/−0.01 to 1 since the cost function is minimised at this value.

The optimum angle of attachment θ to the panel (12) may be determined using two “measures of badness” to find the optimum angle. For example, the standard deviation of the log (dB) magnitude of the response is a measure of “roughness”. Such figures of merit/badness are discussed in International Application WO 99/41939 and corresponding U.S. patent application Ser. No. 09/246,967, of the present applicants the latter of which is incorporated by reference. For an optimised transducer, namely one with aspect ratio of about 1.06:1 and attachment point at about 44% using modelling, rotation of the line of attachment (16) will have a marked effect since the attachment position is not symmetrical. There is a preference for an angle of about 270°, i.e. with the longer end facing left.

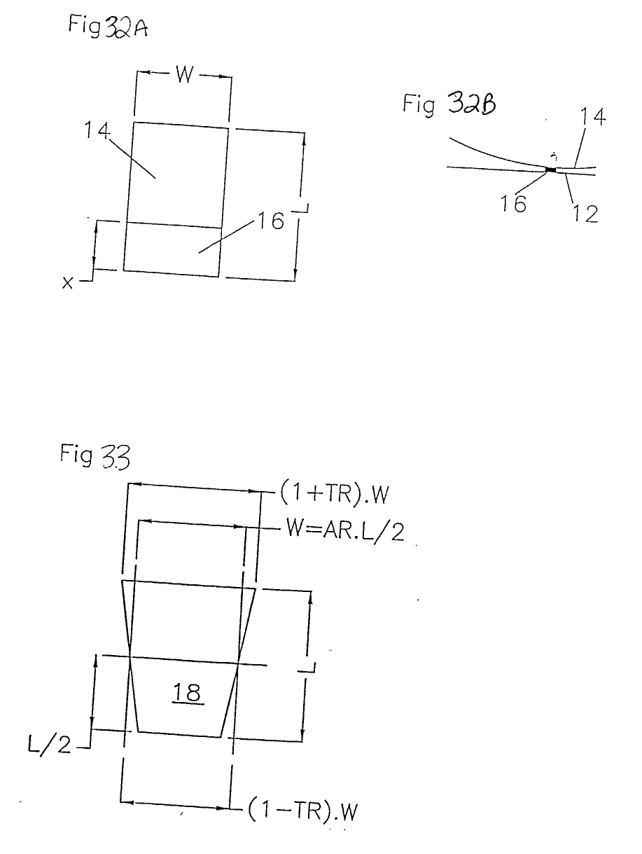

FIG. 33 shows an asymmetrically shaped transducer (18) in the form of a resonant element having a trapezium shaped cross-section. The shape of a trapezium is controlled by two parameters, AR (aspect ratio) and TR (taper ratio). AR and TR determine a third parameter, λ, such that some constraint is satisfied, for example, equal mass either side of the line.

The constraint equation for equal mass (or equal area) is as follows:

$${\int }_{0}^{λ} ( 1 + 2 TR ( \frac{1}{2} - ξ ) ) ⅆ ξ = {\int }_{λ}^{1} ( 1 + 2 TR ( \frac{1}{2} - ξ ) ) ⅆ ξ$$

The above may readily be solved for either TR or λ as the dependent variable, to give:

$$TR = \frac{1 - 2 λ}{2 λ ( 1 - λ )} or λ = \frac{1 + TR - \sqrt{1 + {TR}^{2}}}{2 TR} \approx \frac{1}{2} - \frac{TR}{4}$$

Equivalent expressions are readily obtained for equalising the moments of inertia, or for minimising the total moment of inertia.

The constraint equation for equal moment of inertia (or equal 2nd moment of area) is as follows:

$${\int }_{0}^{λ} ( 1 + 2 TR ( \frac{1}{2} - ξ ) ) {( λ - ξ )}^{2} ⅆ ξ = {\int }_{λ}^{1} ( 1 + 2 TR ( \frac{1}{2} - ξ ) ) {( ξ - λ )}^{2} ⅆ ξ$$

$$TR = \frac{( {λ}^{2} - λ + 1 ) ( 2 λ - 1 )}{2 {λ}^{4} - 4 {λ}^{3} + 2 λ - 1} or λ \approx \frac{1}{2} - \frac{TR}{8}$$

The constraint equation for minimum total moment of inertia is

$$\frac{ⅆ}{ⅆ λ} ( {\int }_{0}^{1} ( 1 + 2 TR ( \frac{1}{2} - ξ ) ) {( λ - ξ )}^{2} ⅆ ξ ) = 0$$

$$TR = 3 - 6 λ or λ = \frac{1}{2} - \frac{TR}{6}$$

A cost function (measure of “badness”) was plotted for the results of 40 FEA runs with AR ranging from 0.9 to 1.25, and TR ranging from 0.1 to 0.5, with λ constrained for equal mass. The transducer is thus mounted at the centre of mass. The results are tabulated below and show that there is an optimum shape with AR=1 and TR=0.3, giving λ at close to 43%.

| tr | λ | 0.9 | 0.95 | 1 | 1.05 | 1.1 | 1.15 | 1.2 | 1.25 |
|---|---|---|---|---|---|---|---|---|---|
| 0.1 | 47.51% | 2.24% | 2.16% | 2.16% | 2.24% | 2.31% | 2.19% | 2.22% | 2.34% |
| 0.2 | 45.05% | 1.59% | 1.61% | 1.56% | 1.57% | 1.50% | 1.53% | 1.66% | 1.85% |
| 0.3 | 42.66% | 1.47% | 1.30% | 1.18% | 1.21% | 1.23% | 1.29% | 1.43% | 1.59% |
| 0.4 | 40.37% | 1.32% | 1.23% | 1.24% | 1.29% | 1.25% | 1.29% | 1.38% | 1.50% |
| 0.5 | 38.20% | 1.48% | 1.44% | 1.48% | 1.54% | 1.56% | 1.58% | 1.60% | 1.76% |

One advantage of a trapezoidal transducer is thus that the transducer may be mounted along a line of attachment which is at its centre of gravity/mass but is not a line of symmetry. Such a transducer would thus have the advantages of improved modal distribution, without being inertially unbalanced. The two methods of comparison used previously again select about 270° to 300° as the optimum angle of orientation.

The transducer used in the present invention may be seen as the reciprocal of a distributed mode panel, e.g. as described in International application WO97/09842 or corresponding U.S. Pat. No. 6,332,029 granted Dec. 12, 2001, in that the transducer is designed to be a distributed mode object.

It should be understood that this invention has been described by way of examples only and that a wide variety of modifications can be made without departing from the scope of the invention as described in the accompanying claims.

We claim:

1. A device comprising a vibration system, comprising:
a vibration component capable of vibrating; and
an electromechanical force transducer mounted to the component to excite vibration in the component, wherein the transducer has an intended operative frequency range and comprises:
a resonant element having a frequency distribution of modes in the operative frequency range; and
a coupler for mounting the transducer to the component.

2. A device according to claim 1, wherein parameters of the resonant element are selected to enhance the distribution of modes in the resonant element in the operative frequency range.

3. A device according to claim 2, wherein the distribution of modes in the resonant element has a density of modes which is sufficient for the resonant element to provide an effective mean average force which is substantially constant with frequency.

4. A device according to claim 2, wherein the modes are distributed substantially evenly over the intended operative frequency range.

5. A device according to claim 1, wherein the resonant element is modal along two substantially normal axes, each axis having an associated fundamental frequency, and wherein the ratio of the two associated fundamental frequencies is adjusted for best modal distribution.

6. A device according to claim 5, wherein the ratio of the two fundamental frequencies is about 9:7.

7. A device according to claim 1, wherein the transducer comprises a plurality of resonant elements each having a distribution of modes, and wherein the modes of the resonant elements are arranged to interleave in the operative frequency range whereby the distribution of modes in the transducer is enhanced.

8. A device according to claim 1, wherein the resonant element is plate-like.

9. A device according to claim 1, wherein the shape of the resonant element is selected from the group consisting of beam-like, trapezoidal, hyperelliptical, substantially disc shaped, and rectangular.

10. A device according to claim 1, wherein the operative frequency range is in the audio range.

11. A device according to claim 10, wherein the device is selected from the group consisting of a dog whistle, a smoke alarm, a rape alarm, a programmable point of sale loudspeaker, a domestic appliance, a car horn, an electronic musical box, a clock, and an integrated loudspeaker.

12. A device according to claim 10, wherein the device is adapted to communicate with a diver, and wherein the vibration component is an underwater support structure against which a diver's helmet is placed for structure borne sound conduction.

13. A device according to claim 10, wherein parameters of the resonant element are selected to enhance the distribution of modes in the resonant element in the operative frequency range.

14. A device according to claim 13, wherein the distribution of modes in the resonant element has a density of modes which is sufficient for the resonant element to provide an effective mean average force which is substantially constant with frequency.

15. A device according to claim 13, wherein the modes are distributed substantially evenly over the intended operative frequency range.

16. A device according to claim 1, wherein the operative frequency range is ultrasonic.

17. A device according to claim 16, wherein the device is selected from the group consisting of an ultrasonic personnel location device, a system for repelling insects or animals, and an ultrasonic motion sensor.

18. A device according to claim 16, wherein parameters of the resonant element are selected to enhance the distribution of modes in the resonant element in the operative frequency range.

19. A device according to claim 18, wherein the distribution of modes in the resonant element has a density of modes which is sufficient for the resonant element to provide an effective mean average force which is substantially constant with frequency.

20. A device according to claim 18, wherein the modes are distributed substantially evenly over the intended operative frequency range.

21. A device according to claim 1, wherein the device is a machine which comprises a mechanism having a mechanical action, and wherein the vibration system is attached to the mechanism to enhance the mechanical action.

22. A device according to claim 21, wherein the machine is selected from the group consisting of a cutter, a vibration sorter, a fluidised bed, a device which is adopted to convert reciprocal to rotating motion, a carpet beater, a vacuum cleaner, a chemical reaction tank, a moving mirror adapted to generate a light display, a welder, and an inkjet printer.

23. A device according to claim 21, wherein parameters of the resonant element are selected to enhance the distribution of modes in the resonant element in the operative frequency range.

24. A device according to claim 23, wherein the distribution of modes in the resonant element is enhanced by ensuring the distribution has a density of modes which is sufficient for the resonant element to provide an effective mean average force which is substantially constant with frequency.

25. A device according to claim 23, wherein the distribution of modes is enhanced by distributing the resonant bending wave modes substantially evenly in frequency.

26. A device according to claim 23, wherein the resonant element is modal along two substantially normal axes, each axis having an associated fundamental frequency, and wherein the ratio of the two associated fundamental frequencies is adjusted for best modal distribution.

27. A device according to claim 26, wherein the ratio of the two fundamental frequencies is about 9:7.

28. A device according to claim 21, wherein the transducer comprises a plurality of resonant elements each having a distribution of modes, and wherein the modes of the resonant elements are arranged to interleave in the operative frequency range whereby the distribution of modes in the transducer as a whole device is enhanced.

29. A device according to claim 28, wherein the distribution of the modes in each resonant element is enhanced by optimising a frequency ratio of the fundamental resonance frequency of each resonant element.

30. A device according to claim 21, wherein the resonant element is plate-like.

31. A device according to claim 30, wherein the shape of the resonant element is selected from the group consisting of beam-like, trapezoidal, hyperelliptical, generally disc shaped, and rectangular.

32. A device according to claim 12, wherein the underwater support structure is an oil rig leg.
